(19) United States
(12) Patent Application Publication
(10) Pub. No.: US 2006/0259498 A1
(43) Pub. Date: Nov. 16, 2006

(54) Signature set content matching

(75) Inventors: Carl M. Ellison, Seattle, WA (US); Eran Yariv, Redmond, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/126,713

(22) Filed: May 11, 2005

(51) Int. Cl. G06F 7/00

(52) U.S. Cl. 707/100

(57) ABSTRACT

Signatures are sought in a source text. These signatures may be defined by regular expressions, and thus may include substrings. These substrings are located by a substring locator may be implemented using a finite state machine or a trie with walkers. When a substring is located, the existence and location of the substring is reported to a signature locator. The signature locator tracks reported substrings and determines whether a signature has been found. Complex signatures are supported which may include, for example, two substrings separated by a specific number of wildcards, or by at least and/or at most a certain number of wildcards. High performance which allows real-time searching of network traffic for signatures is enabled.

### FIELD OF THE INVENTION

The present invention relates generally to the field of software, and more particularly, to content-matching of a stream of data against a number of signatures.

### BACKGROUND OF THE INVENTION

The task of finding a target object within a search area is one which occurs in many contexts. One such context is the one in which a search area is being examined in order to find whether one or more target object or objects exist within it.

For example, the search area may be a stream of data or a large file. One or more target objects are being sought in the search area. The target objects are relatively smaller than the search area, for example, they may be strings of text (signatures) being sought among a stream of characters or a large file of characters. This type of string-searching is known as dictionary-matching, where a target text is searched to find signature(s) from a finite set of signatures. The set of signatures is known as the dictionary.

Performing such dictionary-matching is possible according to prior art methods. For example, the Aho-Corasick algorithm is a string-searching algorithm, originated by Alfred V. Aho and Margaret J. Corasick. According to the Aho-Corasick algorithm, a finite automaton (a finite-state pattern matching machine) is constructed based on the set of target signatures. The automaton can then be applied to the search area in a single pass.

While the Aho-Corasick algorithm provides a solution to the simple dictionary-matching problem, it can only be used to find simple strings. While Aho and Corasick do discuss the inclusion of a wildcard in the string being searched for, this is done by searching for every possible expansion of the wildcard.

For example, Aho and Corasick discuss the use of their algorithm to find target keywords preceded or followed by a punctuation character such as a space, comma or semicolon. (This is done so that, for example, the keyword “ion” will not be deemed to have been found if the source contains the word “motions.”) This is possible when using Aho-Corasick, however, as Aho and Corasick state, “the use of a class of punctuation characters in the keyword syntax creates some states with a large number of goto transitions. This may make the deterministic finite automaton implementation of Algorithm 1 more space-consuming and less attractive for some applications.” Thus, searching for “ion*”, where * represents the space character, the comma character or the semicolon character, is done by searching for the following three strings:

“ion”

“ion,”

“ion;”

Use of Aho-Corasick to find signatures containing wild cards (such as a wild card matching any character, or one, as described above, matching specific characters (e.g. punctuation) is thus problematic, since the expansion of the number of strings searched for in the finite automaton causes resource issues.

In addition to signatures containing wildcards, other complex signatures may also be sought and Aho-Corasick may not be capable of searching for complex signatures. For example, the Aho-Corasick algorithm can not be used to search for a signature which consists of two simple strings occurring in a specific order, but with any number of characters between them. For example, one signature of interest might be the string “ABCDE” followed by the string “FGHIJ,” with any number of characters between them. Other complex signatures may specify a minimum and/or a maximum number of characters between the strings. Generally, it is desirable to be able to search for any string which can be expressed as a regular expression, however, Aho-Corasick cannot provide this capacity.

There are many applications in which such complex signatures may be sought. For example, if network traffic is being examined in order to find offending messages, such as those corresponding to viruses, active attacks on the network, or unacceptable material (e.g. offensive content), the offending messages may be identified by searching for specific complex signatures. Existing methods of searching for complex signatures can not be performed in real time with network traffic, and thus can not allow offending messages to be identified and dealt with without slowing network traffic. Allowing offending messages to go through or slowing network traffic are undesirable options.

Accordingly, there is a need in the art for a system and method that allows for dictionary-matching searches to be performed on complex signatures which is not computational-time prohibitive, e.g. so that such searches can be performed on a source text such as a stream of network traffic.

### SUMMARY OF THE INVENTION

In order to provide efficient dictionary matching to find a set of possibly complex signatures in a source text, substrings are found in the signatures to be examined. These substrings are searched for in the source text, using Aho-Corasick's (or similar) finite automaton. A trie-and-walkers approach may also be used.

When substrings are detected, these substrings are provided as input to a signature locator. The signature locator determines, based on the existence and location of the substrings detected, whether a signature from the set of signatures has been discerned. The signature may do this by means of a trie-and-walkers, where a walker on a node on the trie corresponds to a substring combinations which has been detected in the source which may be part of a signature. Transitions between nodes on the trie are based on the detection of a substring and, possibly, on a satisfaction of a requirement relating to the relative location of substrings that have been detected. Other types of conditions may exist.

The substring locator and signature locator used in serial as described may be used to efficiently find signatures in source text such as, e.g., network traffic.

Other advantages and novel features of the invention may become apparent from the following detailed description of the invention when considered in conjunction with the drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram of an exemplary computing environment in which aspects of the invention may be implemented;

FIG. 2 is a block diagram system for detecting an occurrence of a signature from a set of signatures, according to one embodiment of the invention;

FIG. 3 is a block diagram of a state machine according to one embodiment of the invention;

FIG. 4 is a block diagram of a trie according to one embodiment of the invention;

FIG. 5 is a flow diagram of a method for locating signatures according to one embodiment of the invention; and

FIG. 6 is a block diagram of a system for detecting an occurrence of a signature from a set of signatures, according to one embodiment of the present invention.

### DETAILED DESCRIPTION OF ILLUSTRATIVE EMBODIMENTS

Exemplary Computing Environment

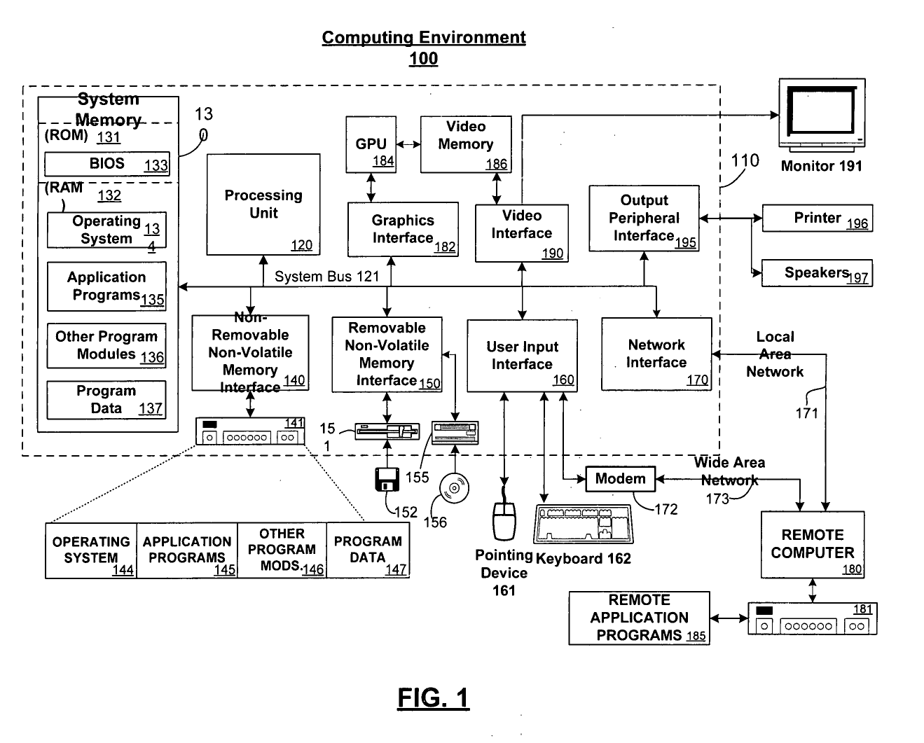

FIG. 1 shows an exemplary computing environment in which aspects of the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary computing environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Signature Set Content Matching

According to some embodiments of the invention, a set of signatures is sought in a source. The source, for example, may be a data stream, such as an incoming stream of network traffic. Alternately, the source may be a data file or files. The data source is a sequentially grouped data consisting of component units arranged in a sequence. For example, component units may be characters, bytes, or other data units. Since comparison of component units from the source with component units of the signatures will be used, in one embodiment, component units are chosen so that two of the component units admit of a simple determination as to whether they are the same or different. In the examples shown below, characters are used as component units, however this is not intended to be limiting.

The signatures being sought, in one embodiment, are any signature composed of the component units which can be described in a regular expression. Thus, one signature could be: “A B C D E”. This looks for the component units ‘A’, ‘B’, ‘C’, ‘D’, and ‘E’, consecutively, with no intervening component units. Another signature could be “A B C w* D E”, where ‘w’ indicates a wildcard character in the regular expression language. This signature is met by the component units ‘A’, ‘B’, ‘C’, sequentially with no intervening component units, followed by any number of component units (including zero component units), and followed by component units ‘D’ and ‘E’, with no component units between them. Instead of an asterisk, indicating any number of wildcards, a minimum and/or a maximum number could also be specified, indicating that at least or at most a certain number of component units must separate the “A B C” part of the signature from the “D E” part of the signature. Generally, any regular expression may be used to specify a signature.

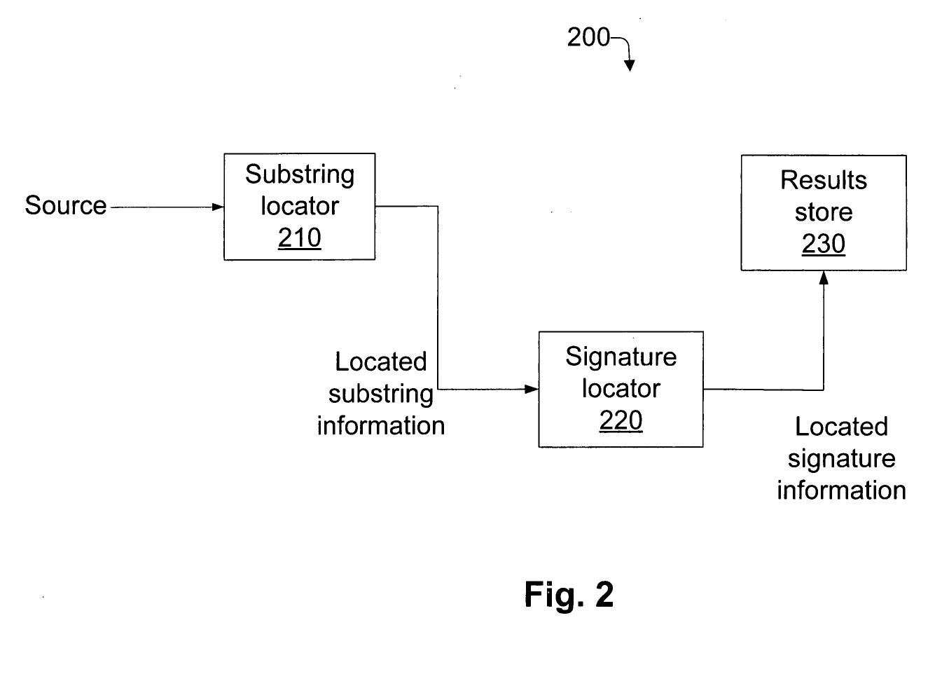

A system for detecting an occurrence of a signature from a set of signatures, according to one embodiment of the invention, is presented in FIG. 2. In FIG. 2, the system 200 consists of substring locator 210, signature locator 220, and results store 230. As can be seen from FIG. 2, the source is an input to substring locator 210. As discussed, the source may be a file, a stream, or another form of data. The source provides a sequential input for substring locator 210. The substring locator 210 locates substrings and reports on their existence and location to signature locator 220. Signature locator 220 locates signatures and reports on their existence and location results store 230.

Substring Locator 210

The substring locator 210 locates any simple substrings in any of the signatures in the set of signatures. In one embodiment, simple substrings include sequential strings of component units. For example, for the signature “ABCw*DE”, two substrings “ABC” and “DE” are included. A signature may contain any number of substrings.

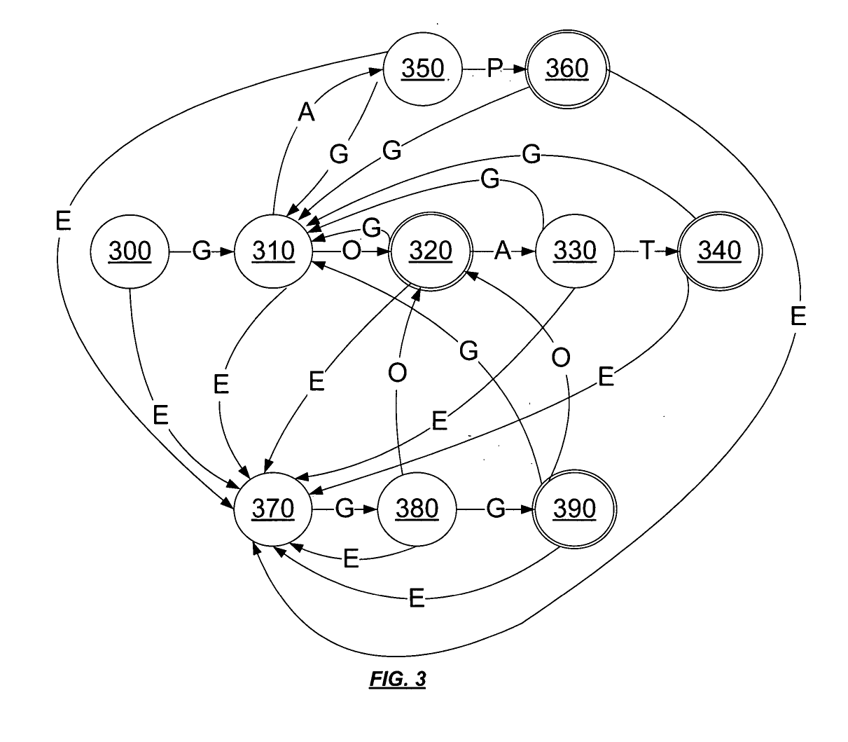

In one embodiment of the invention, substring locator 210 is a finite state machine according to the Aho-Corasick algorithm. FIG. 3 shows a state machine for five substrings according to the Aho-Corasick algorithm. The finite state machine may be represented in various ways, and may be implemented in various ways. While a certain implementation will be described, any implementation of a finite state machine or equivalent functionality is contemplated. For ease of understanding, a state machine with nodes and transitions is used to represent the operation of the finite state machine used for the substring locator. As shown in FIG. 3, the state machine contains a number of states and transitions. The state graph in FIG. 3 includes start state 300, and also includes states 301-309. Transitions between certain of these nodes are indicated by arrows, which are accompanied by the component unit which enables the transition. When a component unit other than one indicated by a transition is encountered, the state machine returns to state 300 (or remains there, if is already in state 300). States 302, 304, 305, and 309 are end-of-substring states. The state machine of FIG. 3 finds the substrings “GO”, “GOAT”, “GAP”, and “EGG”. These correspond to end-of-substring states 302, 304, 306, and 309, respectively.

The finite state machine uses the source as input in order to traverse the tree. The finite state machine begins in the start state. As discussed above, any character encountered other than those corresponding to an arrow from the current state cause the machine to revert to or remain in the start state. Thus, if the first component unit of the source is not a ‘G’ or an ‘E’, the machine remains in state 300. For as long as component units encountered are neither ‘G’ nor ‘E’, the machine remains in that state. If, however, a component unit is encountered that is a ‘G’ or an ‘E’, the state machine transitions to state 301 (for a ‘G’) or state 307 (for an ‘E’). Once in state 301, if the next component unit encountered is an ‘O’, the machine transitions to state 302. If the next component unit encountered is an ‘A’, the machine transitions to state 305. States 304 and 306 contain no transitions, thus, after reaching state 304 and 306, on the next transition the machine returns to state 300 no matter what the next component unit encountered is.

Thus, the machine will use sequential component units to traverse the states as shown in FIG. 3. When an end-of-substring state is reached, the substring and location in the source is reported to the signature locator 220. Each end-of-substring state corresponds to the location of at least one specific substring, and the specific substring or substrings found and their location are reported. (More than one substring found at the same end-of-substring state may occur if, for example, two substrings sought were “BALL” and “BASEBALL”.)

Other overlapping substrings are also handled by the design of the state machine. As the substring “GOAT” contains the substring “GO”, during the operation of the machine, if this substring is encountered in the source, the location and existence of the substring “GO” in the source will be found and reported, followed (after two further transitions) by the reporting of the location and existence of the substring “GOAT” in the source. Thus a second successful substring match may be found even after a successful match of an initial substring match included within second substring.

Additionally, unsuccessful partial matches may lead to successful matches. For example, while “GOAT” might usually be detected by a transition from state 300 to states 301, 302, 303, and 304, if the source contains “EGOAT”, the state machine, after the ‘E’ will be in state 307. The ‘G’ will cause a transition to state 308. If “EGG” were present, the state would then move to 309 on a transition on the second ‘G’. However, since instead ‘O’ is encountered next, the state machine will move from state 308 to state 302, and then to states 303 and 304. Since state 304 is an end-of-substring state, the presence and location of substring “GOAT” will be reported.

Thus, the substring locator 210 may be implemented by a finite state machine.

Trie-and-Walkers Implementation

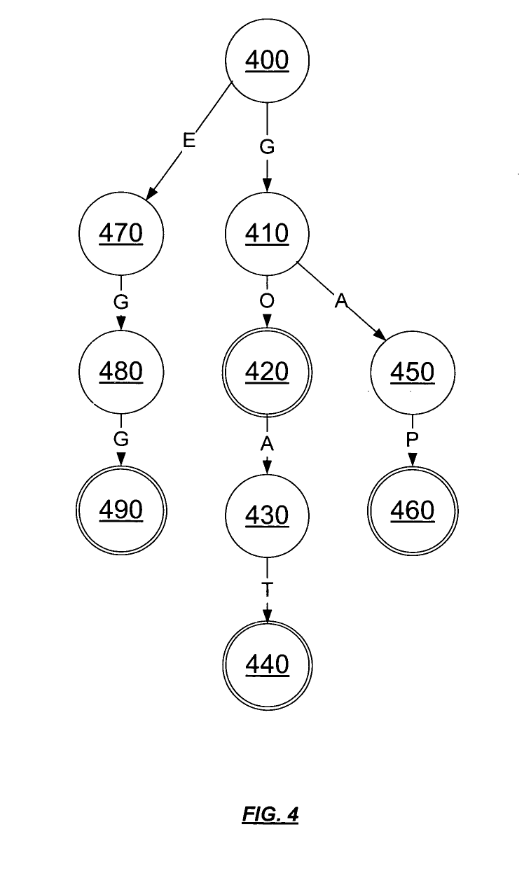

In another embodiment, substring locator 210 is implemented by a trie along with several “walkers” on the trie. A trie is an ordered tree data structure containing nodes and transitions between nodes. A trie which is used to search of substrings “GO”, “GOAT”, “GAP” and “EGG” is shown in FIG. 4. As shown in FIG. 4, a root node 400 allows two transitions, to node 410 on ‘G’ and to node 470 on ‘E’. “GO” is found by transitioning from root node 400 to node 410 and then to 420. All possible transitions are shown in FIG. 4. Any other component unit is invalid.

A trie such as that found shown in FIG. 4 can be used for substring location from a source by supporting multiple walkers on the trie. Before a new component unit received, a new walker is set on root node 400. Then, when the new component unit is received, each existing walker is advanced if a transition exists for that walker on the new component unit. Otherwise, the walker is deleted. For example, if a walker is on root node 400 and “O” is received, that walker can not transition and is deleted. However, if “G” is received, the walker moves to node 410. All walkers are advanced.

Thus, for example, where the source text is “AAAGOAEGOAT”, the walkers exist on the indicated nodes after each source component unit is received as shown in Table 1:

TABLE 1
Example Walkers for Trie of FIG. 4 and Source
Text “AAAGOAEGOAT”

| Source text received | Walkers after source text received |
|---|---|
| A | (none) |
| AA | (none) |
| AAA | (none) |
| AAAG | On node 410 |
| AAAGO | On node 420 |
| AAAGOA | On node 430 |
| AAAGOAE | On node 470 |
| AAAGOAEG | On node 480, On node 410 |
| AAAGOAEGO | On node 420 |
| AAAGOAEGOA | On node 430 |
| AAAGOAEGOAT | On node 440 |

Nodes 420, 440, 460 and 490 are end-of-substring nodes. When a walker reaches an end-of-substring node, the substring found and location are reported. The walker is not deleted. (Thus, in the example above, two occurrences of a walker on node 420 will cause two reports of the existence and location of substring “GO” in the source text, and, the walker which causes the second such report will be moved to node 440 and report the existence and location of substring “GOAT.”

While specific details have been given of this trie-and-walkers substring locator 210 are been given above, different implementations and abstractions of the concepts are contemplated. The trie and walkers may be represented in various ways, and may be implemented in various ways. While a certain implementation has been described, any implementation of a finite state machine or equivalent functionality is contemplated.

Signature Locator 220

Once substrings have been located, the existence and location of the substrings are reported to the signature locator 220. The signature locator 220 takes the existence of substrings and determines whether and where a signature is found in the source. Similarly to the substring locator, the signature locator 220 may be implemented as a trie-and-walker, as a finite state machine, or as some hybrid. The signature locator described below is a trie-and-walker implementation, however no limitation to such an implementation is intended.

As above, nodes in the trie correspond to what has been found so far in the source. However, transitions are informed not by a next component unit received from the source, but by a next substring located. Each transition has at least one condition, which is the determination that a specific substring has been located. However, it may also have additional transitions. Thus, where a signature specifies “ABCw³DEF”, that is, substring “ABC” followed by three characters and then substring “DEF”, a transition between node signifying that “ABC” has been found to another node indicating that the signature has been found is based on both (a) the fact that substring locator 210b has found “DEF” and (b) the location reported for “DEF” indicates that the location of “DEF” is three characters after the location reported for “ABC”. While conditions other than the detection of a transition substring may exist, it may also be the case that the discovery of the transition substring is the only condition. For example, for the situation in which two substrings are separated by zero or more wildcards (“ABCw*DEF”), if a walker is on a node indicating that “ABC” has been detected, no condition other than the detection at any point in time that “DEF” has been detected is needed for transition.

Thus, in one embodiment, in addition to storing, for each walker, a location on the trie for the walker, the signature locator also stores location information for substrings which have been located and used to get to the walker's current location. This location information can then be used to determine, when a new substring is received, whether transition conditions have been met and the walker can advance to a new node location.

In the substring locator 210, when implemented in a trie-and-walkers form, when a new component unit is encountered in the source but no transition exists from a walker's current node, that walker is deleted. However, this is not the case for the signature locator 220 trie-and-walkers implementation. Where the signature sought is “ABCw³DEF”, and another signature sought includes the substring XYZ, source text including “ABCXYZDEF” would lead to the discovery of substrings “ABC”, “XYZ” and “DEF.” After “ABC” is encountered, a walker will be on a node N corresponding to the discovery of “ABC.” The next information received by signature locator 220 is that “XYZ” has been discovered. But even though “XYZ” may not be the substring from any transition from node N does not mean that the walker on node N should be deleted. Indeed, when the substring locator 210 indicates that “DEF” has been found, the signature “ABCw³DEF” will have been found.

It is possible for there to be several walkers at one node. For example, if the signature being sought is “ABCw⁹DEF” and the source text includes “ABCABCAAAABCDEEDEFXXXXXXXXXX” the substring locator 210 may detect several occurrences of substring “ABC” and then one occurrence of the substring “DEF”. The first and third occurrences of the substring “ABC” do not correspond to finding the signature “ABCw⁹DEF”, however the second one does. Thus a walker must be maintained for each occurrence of the substring “ABC” reported by the substring locator 210. When the substring “DEF” is located, the first and third walkers will not transition (because, although “DEF” has been located, the additional condition of relative location has not been met for the first and third occurrence of “ABC”); however, the second walker will transition, and the signature will be detected.

According to one embodiment, a walker is always maintained at the root node. If a walker transitions from the root node, a new walker is created. This allows there to track the beginning substring for any signature.

In one embodiment, each time a substring is located, each walker is examined to determine whether any viable transitions exist from that walker position. For example, if the only transition from node N (as above, corresponding to the discovery of “ABC”) is the discovery of substring “DEF” after three characters, a walker positioned on node N will be deleted if, when the next substring is encountered, the position of the new substring is such that there is no possibility for “DEF” to be discovered after three characters. For example, if a substring was discovered seventeen characters after the discovery of “ABC” then a walker positioned on node N will be deleted. Multiple walkers may exist on one node, only the walkers which have no possibility to make future transitions are deleted. In this way, walkers can be removed which will not lead to the discovery of a signature.

While the substring locator 210 and the signature locator 220 are shown as distinct elements in FIG. 2, their functionality may be combined and they may be implemented together.

Locating Signatures

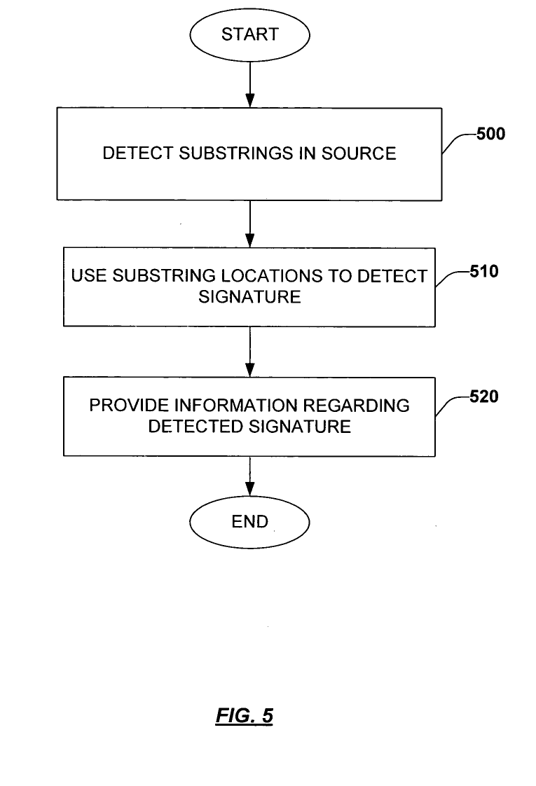

FIG. 5 is a flow diagram of a method for locating signatures according to one embodiment of the invention. As shown in FIG. 5, first, in step 500 substring locations of substrings found in signatures are located. In step 510, at least two substring locations which have been located are used to determine a location of a signature. In step 520, information is provided regarding the detected signature location. Information may be provided, e.g. by signaling a user, or by storing information in a store.

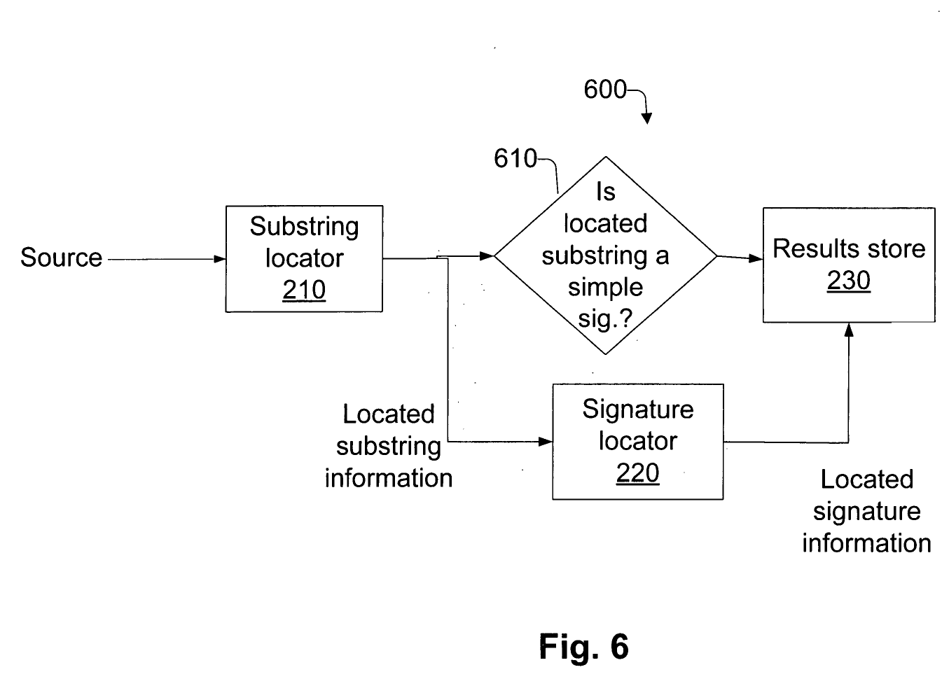

Some signatures may consist solely of substrings. Such “simple signatures” are detected by the substring locator 210. Thus, while the signature locator 220 should be apprised of the detection of the substring (in case it is also part of a more complicated signature), the detection of simple signatures may be left to the substring locator 210. This is shown in FIG. 6. FIG. 6 is a block diagram of a system 600 for determining if a signature has been located, according to one embodiment of the present invention. In FIG. 6, substrings located by substring locator 210 are reported to signature locator 220. However, signature locator 220 only reports on the existence and location of complex signatures. For each substring that has been located, the substring is checked to determine if it matches a simple signature, in decision box 610. If it does, it is reported to results store 230.

Network Traffic Application

As described above, one use for signature set content matching is to find signatures of problematic traffic over a network. In order to perform such signature matching, the network is used as the source. Substrings of interest are detected in the network traffic, and the location of those substrings is tracked. When substrings in the order and placement indicated by the signature are discovered as described above, the signature is reported as found in the network traffic.

### CONCLUSION

It is noted that the foregoing examples have been provided merely for the purpose of explanation and are in no way to be construed as limiting of the present invention. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed:

1. A computer-implemented method for detecting, in a source, an appearance of a signature from a set of at least one signatures, where said signatures comprise signatures which can be expressed by regular expressions, said method comprising:
detecting, in said source, a substring location of any substring from among a set of substrings, each of said substrings appearing in at least one of said signatures;
using at least two detected substring locations of said substrings, detecting a signature location of a signature from said set of at least one signatures; and
providing said information regarding said signature location.

2. The method of claim 1, where said provision of information comprises:
notifying a user of said signature location.

3. The method of claim 1, where said provision of information regarding said signature location comprises:
storing signature location information.

4. The method of claim 1, where said detecting a substring location in a source comprises:
using an implementation of the Aho-Corasick algorithm.

5. The method of claim 1, where said source is comprised of ordered source units selected from among a set of component units with repetition allowed, where each of said substrings is comprised of component units selected from among said set of component units with repetition allowed, and where detecting a substring location in a source comprises:
creating a trie, where, for each of said substrings, a corresponding path exists in said trie from a root node to a end-of-substring node;
tracking at least one walker positions on said trie;
changing each of said walker positions by considering a sequential source unit from said source, determining for each of said walker positions if said sequential source unit corresponds to a move from said walker position to a new walker position down said trie, if said sequential source unit does so correspond, tracking said new walker position, and if said sequential source unit does not so correspond, removing said walker position from those being tracked; and
determining that a substring has been detected in said source if a walker position indicates an end-of-substring node corresponding to one of said substrings.

6. The method of claim 5, further comprising:
before each sequential source unit is considered, adding a walker position at the root node of said trie.

7. The method of claim 1, where said detecting a signature location comprises:
creating a trie, where, for each of said signatures, a corresponding path exists in said trie from a root node to a leaf nodes, where valid transitions from one node to a second node in said trie are based on a condition set comprising least one condition, where one of said conditions is the detection of a substring;
tracking at least one walker positions on said trie;
adding a walker position at said root node;
changing each of said walker positions by considering, sequentially, detected substrings in said source, and for each such detected substring, determining for each of said walker positions if said substring corresponds to a transition from said walker position to a new walker position down said trie, and if so, whether all other conditions in said condition set corresponding to said transition have been met, and if so, tracking said new walker position; and
determining that a signature has been detected in said source if a walker position indicates the end position of a path corresponding to one of said signatures.

8. The method of claim 7, further comprising:
determining whether, for any walker position, for each possible transition from said walker position to a new walker position, at least one condition from said set of conditions corresponding to said transition can not be met; and
removing a specific walker position if it is determined for said specific walker position that for each possible transition from said walker position said at least one condition from said set of conditions corresponding to said transition can not be met.

9. The method of claim 7, where, for at least one transition corresponding to at least one specific signature, said specific signature comprising at least a first substring and a second substring, at least one of said conditions in said associated condition sets comprises a condition regarding relative locations of said first substring and said second substring.

10. The method of claim 1, further comprising:
detecting an appearance of a signature from a second set of at least one simple signatures, where each of said simple signatures is a substring;
if one of said simple signatures has been located, providing said information regarding said simple signature location.

11. The method of claim 10, where a single process is used to perform both said detection of a substring location and said detecting an appearance of a signature from a second set of at least one simple signatures.

12. A computer-implemented system for detecting, in a source, an appearance of a signature from a set of at least one signatures, where said signatures comprise signatures which can be expressed by regular expressions, said system comprising:
a substring detector that detects, in said source, a substring location of any substring from among a set of substrings, each of said substrings appearing in at least one of said signatures;
a signature detector that detects a signature location using said detected substring locations; and
results store that, if one of said signatures has been located, stores said information regarding said signature location.

13. The system of claim 12, where said substring detector uses an implementation of the Aho-Corasick algorithm.

14. The system of claim 12, where said source is comprised of ordered source units selected from among a set of component units with repetition allowed, where each of said substrings is comprised of component units selected from among said set of component units with repetition allowed, and where said substring detector (a) creates a trie, where, for each of said substrings, a corresponding path exists in said trie from a root node to an end-of-substring node; (b) tracks at least one walker positions on said trie; (c) changing each of said walker positions by considering a sequential source unit from said source, determining for each of said walker positions if said sequential source unit corresponds to a move from said walker position to a new walker position down said trie, if said sequential source unit does so correspond, tracking said new walker position, and if said sequential source unit does not so correspond, removing said walker position from those being tracked; and (d) determines that a substring has been detected in said source if a walker position indicates an end-of-substring node corresponding to one of said substrings.

15. The system of claim 14, where said substring detector further (e) before each sequential source unit is considered, adding a walker position at the root node of said trie.

16. The system of claim 12, where signature detector (a) creates a trie, where, for each of said signatures, a corresponding path exists in said trie from a root node to an end-of-substring node, where valid transitions from one node to a second node in said trie are based on a condition set comprising least one condition, where one of said conditions is the detection of a substring; (b) tracks at least one walker positions on said trie; (c) adds a walker position at said root node; (d) changes each of said walker positions by considering, sequentially, detected substrings in said source, and for each such detected substring, determining for each of said walker positions if said substring corresponds to a transition from said walker position to a new walker position down said trie, and if so, whether all other conditions in said condition set corresponding to said transition have been met, and if so, tracking said new walker position; and (e) determines that a signature has been detected in said source if a walker position indicates an end-of-substring node corresponding to one of said signatures.

17. The system of claim 16, where said signature detector further (f) determines whether, for any walker position, for each possible transition from said walker position to a new walker position, at least one condition from said set of conditions corresponding to said transition can not be met; and (g) removes a specific walker position if it is determined for said specific walker position that for each possible transition from said walker position said at least one condition from said set of conditions corresponding to said transition can not be met.

18. The system of claim 12, further comprising:
simple signature detector detecting an appearance of a signature from a second set of at least one simple signatures, where each of said simple signatures is a substring;
and where said location provider, if one of said simple signatures has been located, provides said information regarding said simple signature location.

19. The system of claim 18, where said substring detector comprises said simple signature detector.

20. A method for monitoring a stream of network traffic comprised of an ordered stream of bytes for the appearance of a signature from a set of at least one signatures, where said signatures comprise signatures which can be expressed by regular expressions, said method comprising:
detecting in said stream a substring location of any substring from among a set of substrings, each of said substrings appearing in at least one of said signatures, each of said substrings comprised of an ordered list of byte values;
using at least two substring locations of said substrings, detecting a location of one of said signatures; and
providing said information regarding said detected signature location.
